(19) United States
(12) Patent Application Publication
(10) Pub. No.: US 2026/0202781 A1
(43) Pub. Date: Jul. 16, 2026

(54) HEATING DEVICE, FIXING DEVICE, AND IMAGE FORMING APPARATUS

(71) Applicants: Jun OKAMOTO, Tokyo (JP); Yuusuke FURUICHI, Kanagawa (JP)

(72) Inventors: Jun OKAMOTO, Tokyo (JP); Yuusuke FURUICHI, Kanagawa (JP)

(21) Appl. No.: 19/373,715

(22) Filed: Oct. 30, 2025

(30) Foreign Application Priority Data
Jan. 14, 2025 (JP) 2025-004826

(51) Int. Cl. G03G 15/20; H05B 3/06

(52) U.S. Cl. CPC G03G 15/2053; G03G 15/2064; H05B 3/06; G03G 2215/2035

(57) ABSTRACT

A heating device includes a pressure rotator, a heating rotator having a loop and forming a nip, an electrode, an electric conductor, a resistive strip, and a thermal equalizer. The resistive strip inside the loop extends in a longitudinal direction orthogonal to a conveyance direction in which a sheet passes through the nip. In the longitudinal direction, the resistive strip has a central region having a first width in a transverse direction parallel to the conveyance direction, an end region being adjacent to the central region and having an end coupled to the electrode via the electric conductor and a second width in the transverse direction larger than the first width. The thermal equalizer faces an opposite side face of the resistive strip that is opposite to a nip side face of the resistive strip, extends in the longitudinal direction, and includes multiple materials having different specific heat capacities.

### CROSS-REFERENCE TO RELATED APPLICATIONS

This patent application is based on and claims priority pursuant to 35 U.S.C. § 119 (a) to Japanese Patent Application No. 2025-004826, filed on Jan. 14, 2025, in the Japan Patent Office, the entire disclosure of which is hereby incorporated by reference herein.

### BACKGROUND

### Technical Field

The present disclosure relates to a heating device including a resistive strip. In addition, the present disclosure relates to a fixing device and an image forming apparatus that include the heating device.

### Related Art

An image forming apparatus such as a copier or a printer includes a fixing device as an example of a heating device. The fixing device includes a pressure rotator and a heating rotator such as a fixing belt. The pressure rotator and the heating rotator form a nip between the pressure rotator and the heating rotator. A sheet-shaped member to be heated passes through the nip to fix an image onto the sheet-shaped member. The fixing device includes a resistive strip disposed inside the loop of the fixing belt to heat the fixing belt.

### SUMMARY

The present disclosure described herein provides a heating device including a pressure rotator, a heating rotator, an electrode, an electric conductor, a resistive strip, and a thermal equalizer. The heating rotator has a loop and forms a nip between the pressure rotator and the heating rotator. A sheet passes through the nip in a conveyance direction. The electric conductor is coupled to the electrode. The resistive strip is disposed inside the loop of the heating rotator and extends in a longitudinal direction orthogonal to the conveyance direction. The resistive strip has a central region in the longitudinal direction and an end region adjacent to the central region in the longitudinal direction. The central region has a first width in a transverse direction parallel to the conveyance direction and orthogonal to the longitudinal direction. The end region has a second width larger than the first width in the transverse direction. The end region has an end coupled to the electrode via the electric conductor. The resistive strip has a nip side face facing the nip and an opposite side face opposite to the nip side face in a thickness direction orthogonal to the longitudinal direction and the transverse direction. The thermal equalizer faces the opposite side face of the resistive strip, extends in the longitudinal direction, and includes multiple materials having different specific heat capacities.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an image forming apparatus;

FIG. 2 is a schematic diagram illustrating a basic configuration of a fixing device;

FIG. 3 is a plan view of a heater according to a first embodiment;

FIG. 4 is a cross-sectional view of a part around a fixing nip of the fixing device of FIG. 2;

FIG. 5A is views illustrating the configuration of the heating device according to the first embodiment and including a plan view (a) and a cross-sectional view (c) of a heater having a resistive strip, and a plan view (b) and a cross-sectional view (d) of a thermal equalizer;

FIG. 5B is a plan view of a heater according to a comparative example;

FIG. 5C is views illustrating the configuration of the heating device according to a modification and including a plan view (a) of a heater according to the modification and a plan view (b) of a thermal equalizer according to the modification;

FIG. 6 is views illustrating the configuration of the heating device according to a second embodiment and including a plan view (a) and a cross-sectional view (c) of a heater, and a plan view (b) and a cross-sectional view (d) of a thermal equalizer;

FIG. 7A is a plan view of a thermal equalizer according to a modification;

FIG. 7B is a cross-sectional view of the thermal equalizer of FIG. 7A;

FIGS. 7C to 7E are plan views of thermal equalizers according to modifications modified from the thermal equalizer of FIG. 7A;

FIG. 8A is views including a plan view (a) of a heater and plan views (b) to (e) of thermal equalizers according to modifications;

FIG. 8B is cross-sectional views (a) to (d) of thermal equalizers according to modifications;

FIG. 9A is a diagram illustrating a temperature distribution of a fixing belt of a fixing device in the present embodiment when maximum sheets pass through the fixing device;

FIG. 9B is a diagram illustrating a temperature distribution of the fixing belt of FIG. 9A when small sheets pass through the fixing device;

FIG. 9C is a diagram illustrating a temperature distribution of a fixing belt of a fixing device in a comparative example when maximum sheets pass through the fixing device; and

FIG. 9D is a diagram illustrating a temperature distribution of the fixing belt of FIG. 9C when small sheets pass through the fixing device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

With reference to the drawings, descriptions are given below of embodiments of the present disclosure. In the drawings illustrating the following embodiments, like reference signs are allocated to elements having the same function or shape and redundant descriptions thereof are omitted below.

An overall configuration of an image forming apparatus is described below.

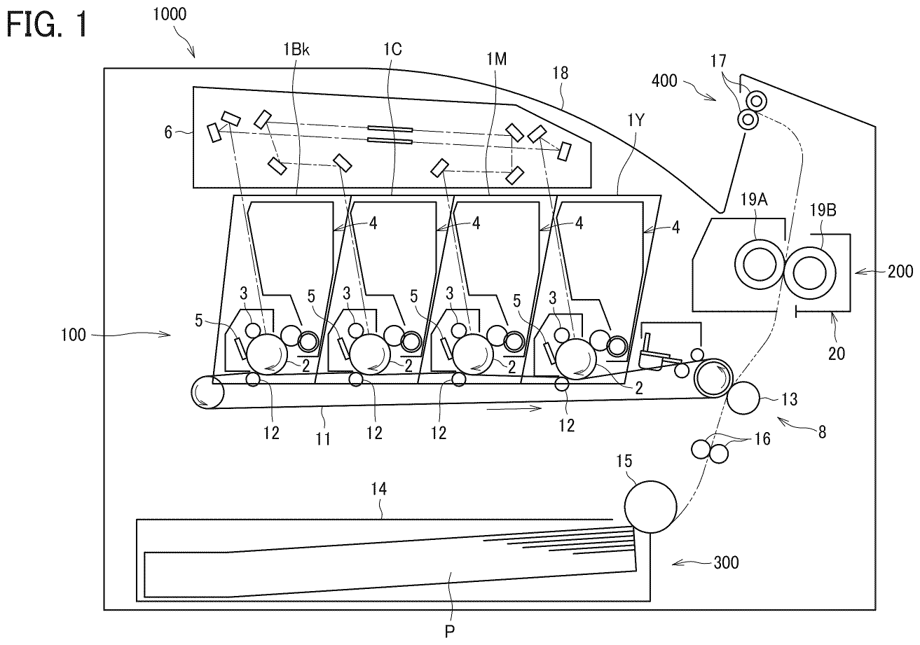

FIG. 1 is a schematic diagram illustrating a configuration of an image forming apparatus 1000. In the following description, the “image forming apparatus” includes a printer, a copier, a facsimile machine, or a multifunction peripheral having at least two of printing, copying, scanning, and facsimile functions.

The term “image formation” used in the following description includes the formation of images with meanings such as characters and figures and the formation of images with no meanings such as patterns. With reference to FIG. 1, a description is given below of the overall configuration and operation of the image forming apparatus 1000. As illustrated in FIG. 1, the image forming apparatus 1000 includes an image forming section 100, a fixing section 200, a sheet feeder 300, and a sheet ejection section 400.

The image forming section 100 is described below.

The image forming section 100 forms an image on a sheet as a recording medium. The image forming section 100 includes four image forming units 1Y, 1M, 1C, and 1Bk, an exposure device 6, and a transfer device 8. Each of the four image forming units 1Y, 1M, 1C, and 1Bk includes a photoconductor 2, a charger 3, a developing device 4, and a cleaner 5.

The photoconductor 2 bears an electrostatic latent image on the surface of the photoconductor 2 and rotates. Examples of the photoconductor 2 includes an endless-shaped photoconductor belt in addition to a drum-shaped photoconductor. The drum-shaped photoconductor 2 is, for example, an inorganic photoconductor such as amorphous silicon or selenium, or an organic photoconductor such as titanyl phthalocyanine.

As the organic photoconductor, there are a laminated photoconductor and a single-layer photoconductor. The laminated photoconductor has a laminated structure containing a layer (a charge generation layer) in which charge-generating materials such as non-metallic phthalocyanine or titanyl phthalocyanine are dispersed in a binder resin and a layer (a charge transport layer) in which charge transport materials are dispersed in a binder resin. These layers are stacked on a support such as an aluminum drum. The single-layer photoconductor has a single-layer structure with a photosensitive layer containing both charge-generating materials and charge transport materials dispersed in a binder resin on a support. In the single-layer photoconductor, it is also possible to add hole transport agents and electron transport agents as charge transport materials to the photosensitive layer. Additionally, the option exists to include an undercoat layer between the support and either the charge-generation layer in the laminated photoconductor or the photosensitive layer in the single-layer photoconductor.

The charger 3 charges the surface of the photoconductor 2. The charging system of the charger 3 is not limited to a particular system as long as the charger 3 applies a voltage to the surface of the photoconductor 2 to uniformly charge the surface of the photoconductor 2. The charging system of the charger 3 can be appropriately selected depending on the purpose. Specifically, examples of the charger 3 include a contact type charger such as a conductive or semiconductive charging roller, a magnetic brush, a fur brush, a film, or a rubber blade, and a non-contact type charger using corona discharge.

The developing device 4 supplies toner as the developer to the electrostatic latent image on the photoconductor 2 to form a toner image. The developing devices 4 accommodate toners (developers) of different colors such as yellow, magenta, cyan, and black in the image forming units 1Y, 1M, 1C, and 1Bk, respectively, corresponding to color separation components of a color image.

The cleaner 5 removes the toner and other foreign matters remaining on the photoconductor 2. Examples of the cleaner 5 include a cleaning blade disposed to be in contact with the surface of the photoconductor 2.

The exposure device 6 exposes the charged surface of the photoconductor 2 to form the electrostatic latent image on the surface of the photoconductor 2. The exposure system of the exposure device 6 is not limited to a particular system as long as the exposure device 6 can expose the charged surface of the photoconductor 2 and can be appropriately selected depending on the purpose. Specific examples of the exposure device include various exposure devices such as a copying optical system, a rod lens array system, a laser optical system, a liquid crystal shutter optical system, and an LED optical system.

The transfer device 8 transfers the toner image onto a sheet. The transfer device 8 includes an intermediate transfer belt 11, primary transfer rollers 12, and a secondary transfer roller 13. The intermediate transfer belt 11 is an endless belt stretched by a plurality of support rollers. Four primary transfer rollers 12 are disposed inside the loop of the intermediate transfer belt 11.

Each of the primary transfer rollers 12 is in contact with the corresponding photoconductor 2 via the intermediate transfer belt 11 to form a primary transfer nip between the intermediate transfer belt 11 and each photoconductor 2. The secondary transfer roller 13 is in contact with the outer circumferential surface of the intermediate transfer belt 11. Thus, the secondary transfer nip is formed between the secondary transfer roller 13 and the intermediate transfer belt 11.

An elastic intermediate transfer belt may be used as the intermediate transfer belt 11. The elastic intermediate transfer belt may include, for example, a rigid base layer having relatively flexibility and a flexible elastic layer layered on the base layer. In addition, the intermediate transfer belt 11 may include a guide on the inner circumferential surface of the intermediate transfer belt to prevent the intermediate transfer belt 11 from meandering.

The fixing section 200 is described below.

The fixing section 200 includes a fixing device 20 that heats the sheet to fix the image on the sheet. The fixing device 20 includes a pair of rotators 19A and 19B contacting each other and a heater heating at least one of the pair of rotators 19A and 19B.

The sheet feeder 300 is described below.

The sheet feeder 300 supplies the sheet to the image forming section 100. The sheet feeder 300 includes a sheet tray 14 to store sheets P as heated members and a feed roller 15 to feed the sheet P from the sheet tray 14. Thus, the secondary transfer nip is formed between the secondary transfer roller 13 and the intermediate transfer belt 11.

Examples of the “heated member” that are sheets include not only a sheet of paper but also an overhead projector (OHP) transparency sheet, a fabric, a metallic sheet, a plastic film, and a prepreg sheet including carbon fibers previously impregnated with resin. Examples of the “sheet” further include thick paper, a postcard, an envelope, thin paper, coated paper (e.g., coat paper and art paper), and tracing paper, in addition to plain paper.

The sheet ejection section 400 is described below.

The sheet ejection section 400 ejects the sheet P to the outside of the image forming apparatus 1000. The sheet ejection section 400 includes an output roller pair 17 to eject the sheet P to the outside of the image forming apparatus 1000 and an output tray 18 to place the sheet P ejected by the output roller pair 17.

An image forming operation is described below.

With continued reference to FIG. 1, the image forming operation of the image forming apparatus 1000 is described below. The image forming operation is started in response to an instruction from an operation panel or external terminals. In each of the image forming units 1Y, 1M, 1C, and 1Bk, the photoconductor 2 starts rotating.

Subsequently, the charger 3 uniformly charges the surface of the photoconductor 2 to a high electric potential. Based on image data of a document read by a document reading device or print data instructed to print by a terminal, the exposure device 6 exposes the charged surface of each of the photoconductors 2.

As a result, the electric potential at an exposed portion on the surface of each of the photoconductors 2 is decreased. Thus, the electrostatic latent image is formed on the surface of each of the photoconductors 2. The developing devices 4 supply toners to the photoconductors 2, respectively, to form toner images of different colors on the photoconductors 2, respectively.

As the photoconductors 2 rotate, the toner images on the photoconductors 2 reach primary transfer nips defined by the positions of the primary transfer rollers 12, respectively. At the primary transfer nips, the toner images are transferred from the photoconductors 2 onto the intermediate transfer belt 11 driven to rotate so as to be sequentially superimposed on one another.

Thus, the full-color toner image is formed on the intermediate transfer belt 11. The image forming operation is not limited to the above-described full color image forming operation that uses all four image forming units 1Y, 1M, 1C, and 1Bk. Alternatively, the image forming apparatus 1000 can form a monochrome toner image by using any one of the four image forming units 1Y, 1M, 1C, and 1Bk, or can form a bicolor toner image or a tricolor toner image by using two or three of the image forming units 1Y, 1M, 1C, and 1Bk.

After the toner image is transferred to the intermediate transfer belt 11, the cleaner 5 removes residual toner remaining on the photoconductor 2 from the surface of the photoconductor 2. As a result, the cleaner 5 removes foreign matter such as residual toner on the photoconductor 2.

The full-color toner image transferred to the intermediate transfer belt 11 is conveyed to the secondary transfer nip defined by the secondary transfer roller 13 in accordance with rotation of the intermediate transfer belt 11. At the secondary transfer nip, the full-color toner image is transferred from the intermediate transfer belt 11 onto the sheet P.

The sheet P is fed from the sheet feeder 300. After the start of the image forming operation, the feed roller 15 rotates to feed the sheet P from the sheet tray 14.

Before the sheet P reaches the secondary transfer nip, the sheet P fed from the sheet tray 14 is brought into contact with a timing roller pair 16 and temporarily stopped. After the sheet P is temporarily stopped, the timing roller pair 16 is rotated at a predetermined time to convey the sheet P to the secondary transfer nip in synchronization with the full-color toner image formed on the intermediate transfer belt 11 reaching the secondary transfer nip. As a result, the full-color toner image is transferred to the sheet P.

The sheet P bearing the full-color toner image is conveyed to the fixing section 200. In the fixing section 200, the sheet P passes between the pair of rotators 19A and 19B, and thus the full-color toner image on the sheet P is heated and pressed to fix the full-color toner image to the sheet P.

Then, the sheet P bearing the fixed toner image is conveyed to the sheet ejection section 400. In the sheet ejection section 400, the output roller pair 17 ejects the sheet P onto the output tray 18. Thus, a series of image forming operations is completed.

The basic configuration of the fixing device 20 is described below.

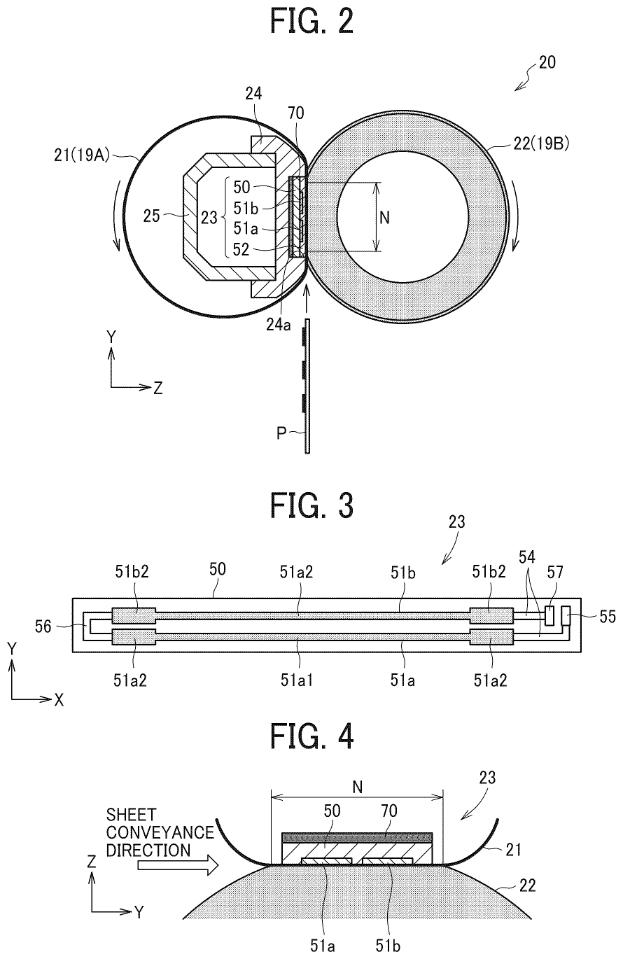

FIG. 2 is a schematic diagram illustrating the basic configuration of the fixing device 20. As illustrated in FIG. 2, the fixing device 20 includes a heater 23, a heater holder 24, and a stay 25 in addition to the pair of rotators 19A and 19B.

The pair of rotators 19A and 19B includes a first rotator 19A that is a fixing belt 21 disposed to contact an unfixed toner image on a surface of the sheet P. The fixing belt 21 is an example of a heating rotator. The pair of rotators 19A and 19B includes a second rotator 19B that is a pressure roller 22 disposed to face the fixing belt 21. The pressure roller 22 is an example of a pressure rotator.

A pressure member such as a spring presses the fixing belt 21 and the pressure roller 22 to be in contact with each other. As a result, a fixing nip N is formed between the fixing belt 21 and the pressure roller 22.

The fixing belt 21 is an endless belt including a tubular base and a release layer on an outer circumferential surface of the base. The base is made of metal such as nickel or stainless steel or resin such as polyimide.

The release layer is made of, for example, tetrafluoroethylene-perfluoroalkylvinylether copolymer (PFA), polytetrafluoroethylene (PTFE), polyimide, polyetherimide, or polyether sulfide (PES). The release layer of the fixing belt 21 facilitates the separation of toner contained in the toner image from the fixing belt 21 and prevents the sheet P from adhering to and wrapping around the fixing belt 21.

The fixing belt 21 may include an elastic layer between the base and the release layer. Examples of the material of the elastic layer include rubber such as silicone rubber, silicone rubber foam, and fluororubber. The elastic layer of the fixing belt 21 prevents the fixing belt 21 from forming slight surface asperities, thus facilitating the uniform conduction of heat to the toner image on the sheet P and enhancing fixing quality.

The pressure roller 22 includes a solid or hollow cored bar, an elastic layer on the outer circumferential surface of the cored bar, and a release layer on the outer circumferential surface of the elastic layer. The cored bar is made of metal such as iron.

Examples of the material of the elastic layer include silicone rubber, silicone rubber foam, and fluororubber. The release layer is made of fluororesin such as PFA or PTFE.

The heater 23 heats the fixing belt 21. The heater 23 is disposed inside the loop of the fixing belt 21 as the heating rotator. The heater 23 has a plate shape or a planar shape and contacts the inner circumferential surface of the fixing belt 21.

At a position where the fixing belt 21 faces the pressure roller 22, the heater 23 contacts the inner circumferential surface of the fixing belt 21 to form the fixing nip N between the fixing belt 21 and the pressure roller 22. The heater 23 may be in direct contact with the inner circumferential surface of the fixing belt 21 or may be in indirect contact with the inner circumferential surface of the fixing belt 21 via a low-friction slide sheet. In the present specification, unless otherwise specified, the meaning of “contact” includes direct contact and indirect contact. In the direct contact, a first member is in contact with a second member via no member. In the indirect contact, a third member is in contact with a fourth member via a fifth member.

The heater 23 includes a base 50, two parallel rows of resistive strips 51a and 51b, and an insulation layer 52. The resistive strips 51a and 51b are disposed on the base 50 and covered with the insulation layer 52.

When power is supplied to the resistive strips 51a and 51b, the resistive strips 51a and 51b generate heat. The heat is transferred to the inner circumferential surface of the fixing belt 21 via the insulation layer 52 to heat the fixing belt 21. Alternatively, the heater 23 may be turned inside out so that the base 50 is in contact with the inner circumferential surface of the fixing belt 21. In this case, since the heat of the resistive strips 51a and 51b is transmitted to the fixing belt 21 through the base 50, it is preferable that the base 50 be made of a material with high thermal conductivity.

The base 50 is made of material having heat resistance and insulation properties, such as ceramic such as alumina or aluminum nitride, or non-metal material such as glass or mica. Interposing another insulation layer between the base 50 and the resistive strips 51a and 51b enables using conductive material such as metal as the material of the base 50.

Low-cost aluminum or stainless steel is favorable as the metal material of the base 50. To reduce the temperature unevenness of the heater 23 and enhance image quality, the base 50 may be made of material having high thermal conductivity, such as copper, graphite, or graphene. Graphene is formed by bonding of carbon atoms and has a sheet shape.

The resistive strips 51a and 51b are formed by, for example, screen-printing. The resistive strips 51a and 51b are produced by, for example, mixing silver-palladium (AgPd) and glass powder into a paste. The paste is coated on the base 50 by screen printing. Subsequently, the base 50 is fired to form the resistive strips 51a and 51b.

The material of the resistive strips 51a and 51b may contain a resistance material, such as silver alloy (e.g., AgPt) or ruthenium oxide (RuO₂) in addition to silver-palladium. The insulation layer 52 may be made of, for example, heat-resistant glass.

The heater holder 24 holds the heater 23. The heater holder 24 accommodates the heater 23 in a recess 24a to restrict the movement of the heater 23 in the vertical direction in FIG. 2 and the direction orthogonal to the paper surface in which FIG. 2 is drawn.

Since the heater holder 24 is heated to a high temperature by heat from the heater 23, the heater holder 24 is preferably made of a heat resistant material. In particular, the heater holder 24 made of heat-resistant resin having low thermal conduction, such as a liquid crystal polymer (LCP), reduces unnecessary heat transfer from the heater 23 to the heater holder 24, thus increasing the heating efficiency of the heater 23.

The stay 25 supports the heater holder 24. The stay 25 supports a stay side face of the heater holder 24. The stay side face is opposite a nip side face of the heater holder 24. The nip side face faces the pressure roller 22. Accordingly, the stay 25 prevents the heater 23 from being bent by a pressing force of the pressure roller 22. As a result, the fixing nip N having a uniform width is formed between the fixing belt 21 and the pressure roller 22. The stay 25 is preferably made of iron-based metal such as steel use stainless (SUS) or steel electrolytic cold commercial (SECC) to enhance the rigidity.

The following describes the operation of the fixing device 20.

The fixing device 20 operates as follows. When the image forming operation starts, a driver starts driving to rotate the pressure roller 22 in a direction indicated by an arrow in FIG. 2, and the rotation of the pressure roller 22 rotates the fixing belt 21. A power source starts supplying power to the heater 23, and the heater 23 generates heat to heat the fixing belt 21.

After the temperature of the fixing belt 21 reaches a specified target temperature, the sheet P bearing the unfixed image is conveyed to the fixing nip N between the fixing belt 21 and the pressure roller 22. As a result, the unfixed toner image on the sheet P is heated and pressed to be fixed on the sheet P. The sheet P is ejected from the fixing nip N and conveyed to the sheet ejection section 400.

A heater configuration is described below.

FIG. 3 is a plan view of a basic configuration of the heater 23 according to a first embodiment. FIG. 4 is a schematic cross-sectional view of a part around the fixing nip Nin FIG. 2. As illustrated in FIGS. 3 and 4, the heater 23 according to the first embodiment includes a pair of end electrodes 55 and 57 to supply power to the resistive strips 51a and 51b and multiple electric conductors 54 and 56 in addition to the base 50, the two parallel rows of resistive strips 51a and 51b, and the insulation layer 52.

In the following description, a transverse direction Y is defined as a direction parallel to a conveyance direction in which the sheet P passes through the fixing nip N, and a longitudinal direction X is defined as a direction orthogonal to the transverse direction. The base 50 is a longitudinal plate arranged to extend in the longitudinal direction X. The two parallel rows of resistive strips 51a and 51b are on the base 50 and extend in the longitudinal direction X.

The pair of end electrodes 55 and 57 are at the end of the base 50 in the longitudinal direction. The end electrodes 55 and 57 are coupled to one ends of the resistive strips 51a and 51b (in other words, one ends of end regions 51a2 and 51b2) via the electric conductors 54. The other ends of the resistive strips 51a and 51b (end regions 51a2 and 51b2) are connected in series to each other by the electric conductor 56.

The electric conductors 54 and 56 are covered with the insulation layer 52 in the same manner as the resistive strips 51a and 51b in order to obtain insulation and durability. However, the insulation layer 52 does not cover the end electrodes 55 and 57 to expose the end electrodes 55 and 57 as power supply terminals so as to be connected to the connectors. Connecting the connectors to the end electrodes 55 and 57 enables a power source (an alternating-current (AC) power source) disposed in the body of the image forming apparatus to supply power to the resistive strips 51a and 51b.

The resistive strips 51a and 51b have central regions 51a1 and 51b1 and end regions 51a2 and 51b2, respectively. The end regions 51a2 and 51b2 are adjacent to the central regions 51a1 and 51b1 in the longitudinal direction X, respectively. The central regions 51a1 and 51b1 are in center portions of the resistive strips 51a and 51b, respectively. Each of the central regions 51a1 and 51b1 has a first width in the transverse direction that is constant in the longitudinal direction. The end regions 51a2 are at both ends of the resistive strip 51a in the longitudinal direction X. The end regions 51b2 are at both ends of the resistive strip 51b in the longitudinal direction X. Each of the end regions 51a2 and 51b2 has a second width in the transverse direction that is constant in the longitudinal direction X and larger than the first width.

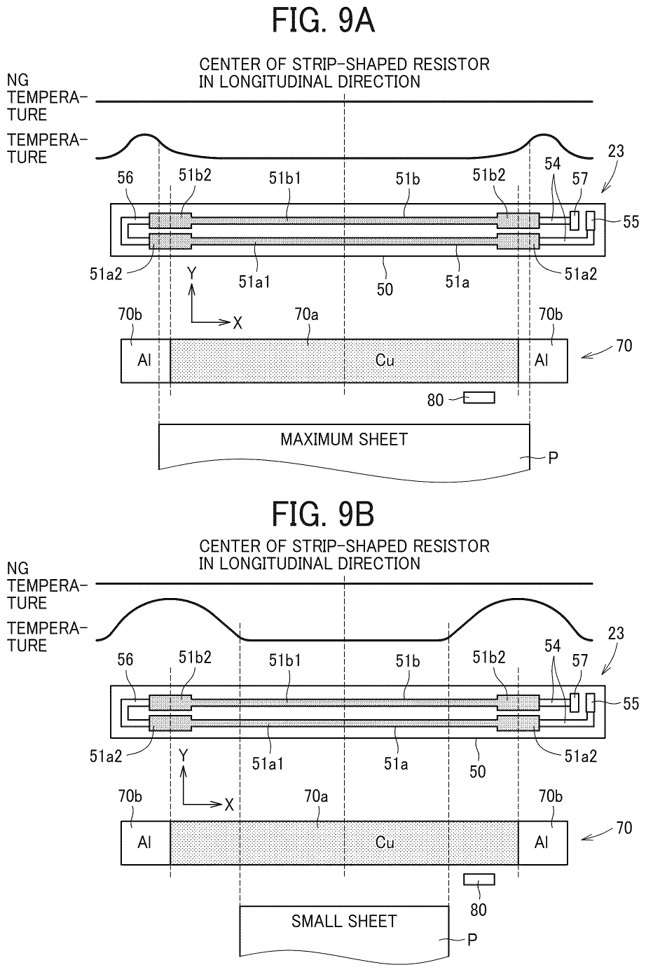

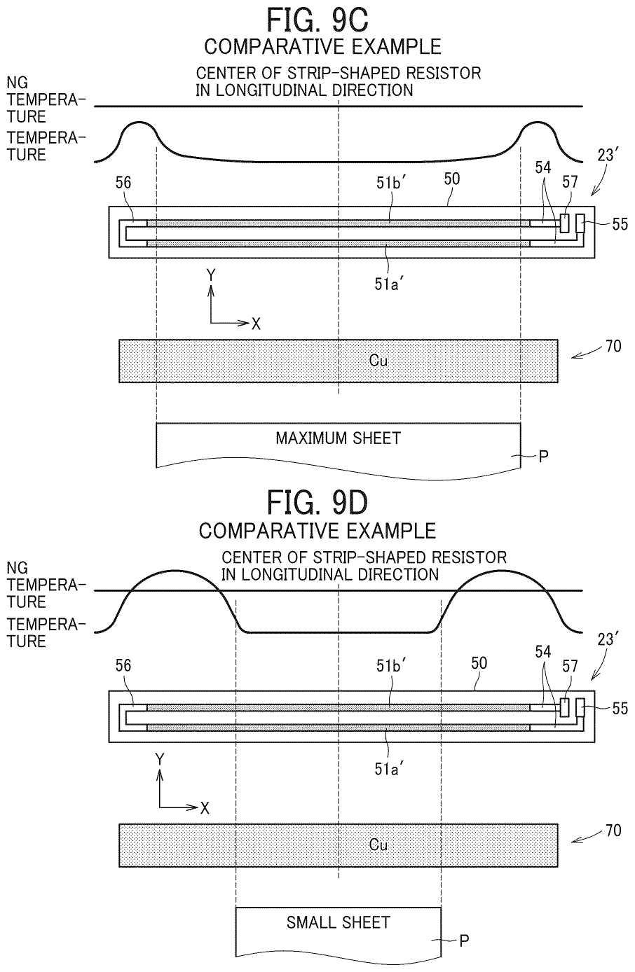

In the image forming apparatus 1000, sheets of various sizes are used. In the following description, a sheet having the maximum width of the widths, in the longitudinal direction X, of sheets passable in the image forming apparatus 1000 is referred to as the maximum sheet. A region in which the sheets contact and pass through the fixing belt 21 is referred to as a passing region. In addition, a region on the fixing belt 21 outside the passing region in the longitudinal direction is referred to as a non-passing region. The maximum sheet dose not contact the non-passing region. The non-passing region may be referred to as a non-sheet-passing region. The central regions 51a1 and 51b1 are formed corresponding to the width of the maximum sheet in the longitudinal direction X as illustrated in FIG. 9A. In the present embodiments, the central regions 51a1 and 51b1 are formed inside a range of the maximum sheet in the longitudinal direction X.

The end regions 51a2 and 51b2 are formed corresponding to the non-sheet-passing regions as illustrated in FIG. 9A. In the present embodiments, the end regions 51a2 and 51b2 are formed so as to overlap with both ends of the maximum sheet in the longitudinal direction X.

Setting the widths of the end regions 51a2 and 51b2 in the transverse direction Y to be larger than the widths of the central regions 51a1 and 51b1 in the transverse direction Y reduces the heat generation amounts of the end regions 51a2 and 51b2 to be smaller than the heat generation amounts of the central regions 51a1 and 51b1. As a result, the above-described configuration can reduce the excessive temperature rise in the non-sheet-passing region of the fixing belt 21 as illustrated in FIGS. 9A and 9B.

A thermal equalizer 70 is described below.

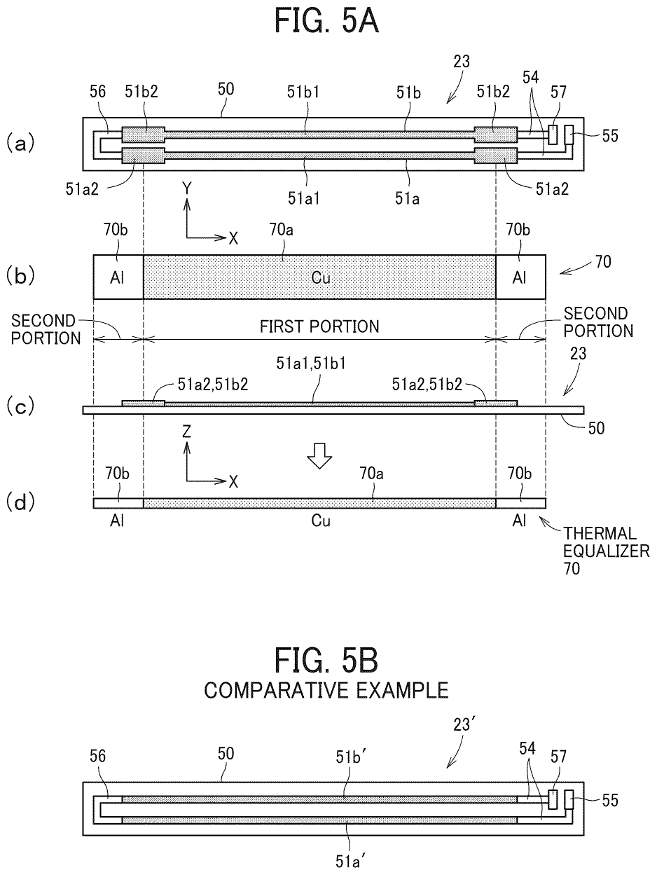

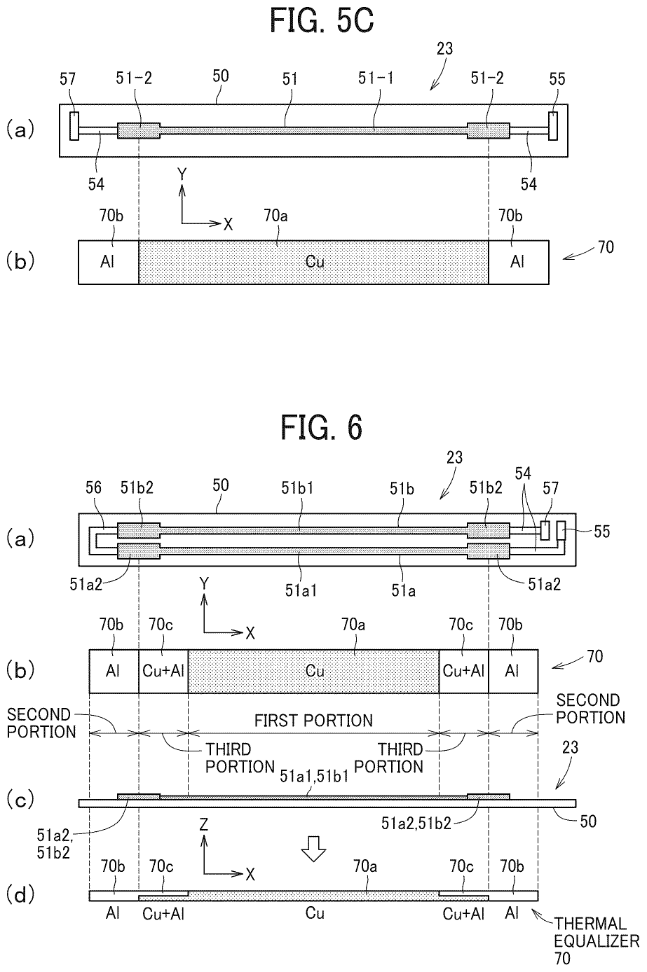

As illustrated in FIG. 2, the fixing device 20 as the heating device includes the thermal equalizer 70 on the base 50 of the heater 23. The front side of the base 50 faces the fixing nip N, and the thermal equalizer 70 is disposed on the back side of the base 50. In other words, each of the resistive strips 51a and 51b has a nip side face facing the fixing nip N and an opposite side face opposite to the nip side face, and the thermal equalizer 70 is disposed so as to face the opposite side face of each of the resistive strips 51a and 51b. As illustrated in (b) and (d) of FIG. 5A, the thermal equalizer 70 has a plate shape. The thermal equalizer 70 conducts heat generated by the resistive strips 51a and 51b in the longitudinal direction X of the base 50 to keep a temperature balance in the longitudinal direction X and prevent temperature drop at the end of the fixing belt and excessive temperature rise in the non-sheet-passing region. Further, the thermal equalizer 70 also has an effect of delaying the temperature rise in the non-sheet-passing region.

In the present embodiments, the thermal equalizer 70 is made of a clad material of copper (Cu) and aluminum (Al). In the clad material, two or more different metals are bonded by diffusion bonding. The clad material provides composite properties that cannot be obtained with a single material. The clad material includes different kinds of metals bonded to each other, but the metals are extremely difficult to peel off as compared with plating.

The following tables 1 and 2 illustrate thermal conductivities [w/m·K] and specific heat capacities [kJ/(kg·K)] of four metal materials. The four metal materials are zinc (Zn), aluminum (Al), iron (Fe), and copper (Cu).

TABLE 1

| | Temperature | Thermal Conductivity |
|---|---|---|
| Material | [K] | [w/m · K] |
| Zinc Zn | 300 | 121 |
| Aluminum Al | 300 | 237 |
| Iron Fe | 300 | 80.3 |
| Copper Cu | 300 | 398 |

TABLE 2

| | Temperature | Specific Heat |
|---|---|---|
| Material | [K] | Capacity [kJ/(kg · K)] |
| Zinc Zn | 300 | 0.389 |
| Aluminum Al | 300 | 0.905 |
| Iron Fe | 300 | 0.442 |
| Copper Cu | 300 | 0.386 |

As can be seen from Table 1, the thermal conductivity of copper (Cu), 398 [w/m·K], is greater than the thermal conductivity of aluminum (Al), 237 [w/m·K]. As can be seen from Table 2, the specific heat capacity of aluminum (Al), 0.905 [KJ/(kg·K)], is larger than the specific heat capacity of copper (Cu), 0.386 [KJ/(kg·K)].

Since copper (Cu) has a high thermal conductivity and a small specific heat capacity, copper (Cu) is the most suitable metal material among the four metal materials for maintaining the temperature of a sheet-passing region of the fixing belt 21 at a predetermined target temperature. Since aluminum (Al) has a low thermal conductivity and a large specific heat capacity, aluminum (Al) is the most suitable metal material among the four metal materials for reducing the excessive temperature rise at the non-sheet-passing region.

Accordingly, the thermal equalizer 70 made of the clad material including copper (Cu) and aluminum (Al) can reduce the excessive temperature rise at the non-sheet-passing region of the fixing belt 21 as illustrated in FIGS. 9A and 9B to be smaller than the excessive temperature rise at the non-sheet-passing region in a fixing device according to a comparative example illustrated in FIGS. 9C and 9D.

The thermal equalizer 70 includes a first portion 70a forming a central portion of the thermal equalizer 70 in the longitudinal direction X, and the first portion 70a is made of copper (Cu). The first portion 70a made of copper (Cu) overlaps the central regions 51a1 and 51b1 of the resistive strips 51a and 51b in the thickness direction Z of the resistive strips 51a and 51b and the thermal equalizer 70. In the present embodiments, the thickness direction is orthogonal to the longitudinal direction and the transverse direction. In the first embodiment, the central regions 51a1 and 51b1 are inside a range of the first portion 70a in the longitudinal direction X.

Additionally, the thermal equalizer 70 includes second portions 70b forming both end portions of the thermal equalizer 70 in the longitudinal direction X, and the second portion 70b is made of aluminum (Al). The second portions 70b made of aluminum (Al) overlap the end regions 51a2 and 51b2 of the resistive strips 51a and 51b in the thickness direction Z of the resistive strips 51a and 51b. In the first embodiment, a part of each of the end regions 51a2 and 51b2 are inside a range of each of the second portions 70b in the longitudinal direction X.

In addition, each of the end regions 51a2 and 51b2 of the resistive strips 51a and 51b is on the boundary between the first portion 70a made of copper (Cu) and the second portion 70b made of aluminum (Al) of the thermal equalizer 70. In other words, each of the end regions 51a2 and 51b2 overlaps the boundary in the thickness direction Z. Forming the central portion of the thermal equalizer 70 in the longitudinal direction X with the material having a small specific heat capacity and forming the end portions of the thermal equalizer 70 with the material having a large specific heat capacity keeps a temperature balance of the fixing belt 21 in the longitudinal direction X and prevents the temperature drop at the end of the fixing belt and the excessive temperature rise in the non-sheet-passing region.

In a unit length in the longitudinal direction X, an amount of heat generated by each of the end regions 51a2 and 51b2 of the resistive strips 51a and 51b is smaller than an amount of heat generated by each of the central regions 51a1 and 51b1. In other words, each of the end regions 51a2 and 51b2 is a low heat generation portion. The low heat generation portion contacting both the first portion 70a made of copper (Cu) and the second portion 70b made of aluminum (Al) can effectively prevent the temperature drop at the end portion of the heater while large sheets are printed and the temperature rise at the end portion of the heater while small sheets are printed. In contrast, a heater 23′ according to the comparative example illustrated in FIG. 5B includes resistive strips 51a′ and 51b′ each having a width in the transverse direction Y that is constant over the longitudinal direction X. Additionally, a fixing device according to the comparative example includes a thermal equalizer made of a single material (Cu). This configuration cannot prevent the temperature drop at the end portion and the excessive temperature rise at the end portion.

The arrangement, number, shape of each of the resistive strips 51a and 51b, the end electrodes 55 and 57, and the electric conductors 54 and 56 are not limited to the example illustrated in FIG. 5A and may be appropriately changed. The resistive strips 51a and 51b may be formed in three or more rows in addition to in two rows as illustrated in FIG. 5A (a). The resistive strip 51a may be arranged in a line as illustrated in FIG. 5C.

A heater according to a second embodiment is described below.

FIG. 6 is views illustrating the heater 23 according to the second embodiment. The thermal equalizer 70 in the second embodiment includes three portions: the first portion 70a made of copper (Cu), the second portion 70b made of aluminum (Al), and a third portion 70c made of a laminate of copper (Cu) and aluminum (Al). As a result, the third portion 70c includes multiple layers layered in the thickness direction and having different specific heat capacities. These three portions have different specific heat capacities.

Specifically, the first portion 70a made of copper (Cu) having the smallest specific heat capacity forms a center portion of the thermal equalizer 70 in the longitudinal direction and faces the central regions 51a1 and 51b1 of the resistive strips 51a and 51b in the thickness direction Z. The second portions 70b having the largest specific heat capacity form end portions of the thermal equalizer 70 in the longitudinal direction and face the end regions 51a2 and 51b2 of the resistive strips 51a and 51b in the thickness direction Z. The third portion 70c having an intermediate specific heat capacity is disposed between the first portion 70a and the second portion 70b.

The end regions 51a2 and 51b2 of the resistive strips 51a and 51b overlap the boundary between the second portion 70b and the third portion 70c of the thermal equalizer 70 in the thickness direction Z. Arranging portions having different specific heat capacities so that the specific heat capacity increases from the center of the thermal equalizer 70 to the end of the thermal equalizer 70 in the longitudinal direction X keeps a temperature balance of the fixing belt 21 in the longitudinal direction X and prevents the temperature drop at the end of the fixing belt 21 and the excessive temperature rise in the non-sheet-passing region.

As described above, the end regions 51a2 and 51b2 of the resistive strips 51a and 51b are the low heat generation portions. The low heat generation portion contacting both the second portion 70b made of aluminum (Al) having the largest specific heat capacity and the third portion 70c made by the laminate of copper (Cu) and aluminum (Al) and having the intermediate specific heat capacity can effectively prevent the temperature drop at the end portion of the heater while large sheets are printed and the temperature rise at the end portion of the heater while small sheets are printed.

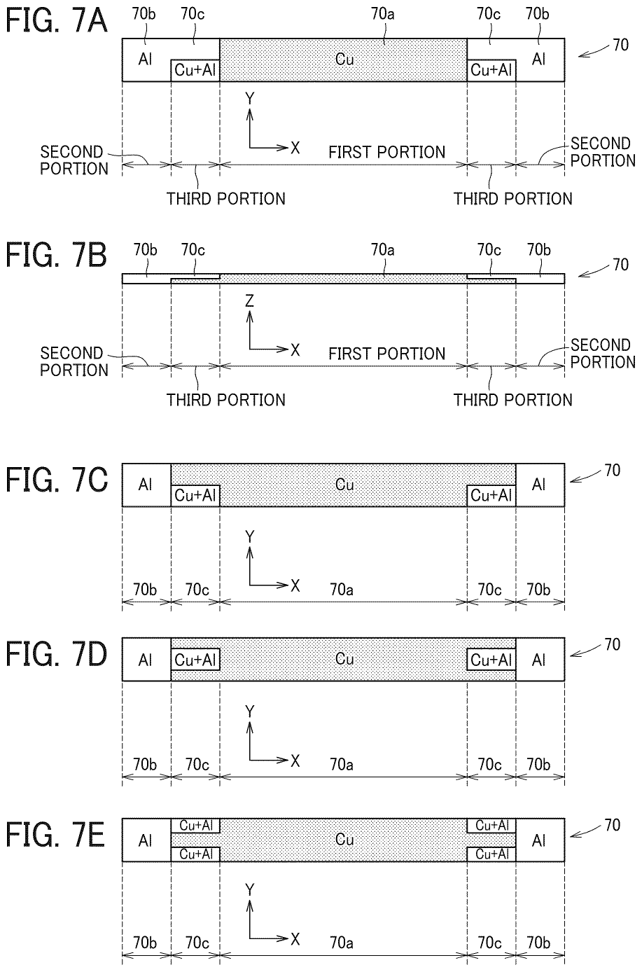

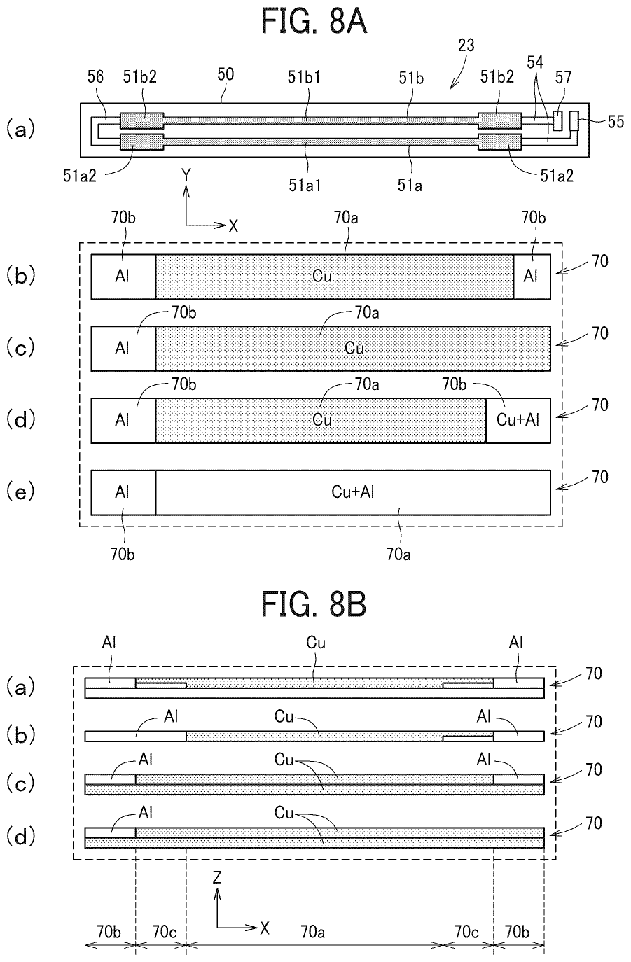

With reference to FIGS. 7A to 8B, the thermal equalizers 70 according to modifications are described below. These modifications can provide fine thermal characteristics.

In FIGS. 7A and 7B, the third portion 70c includes a part made of copper (Cu) and a part made of aluminum (Al). The part made of copper (Cu) extends from the first portion 70a and forms the back side of the thermal equalizer 70. The part made of aluminum (Al) extends from the second portion 70b and forms the front side of the thermal equalizer 70.

As illustrated in FIG. 7A, the third portion 70c may include one end in the transverse direction made of aluminum (Al) and extending from the second portion 70b. In addition, as illustrated in FIGS. 7A and 7B, the part made of aluminum (Al) may be overlaid on the part made of copper (Cu) in the thickness direction Z to form the other end of the third portion 70c in the transverse direction.

As described above, the third portion 70c includes multiple rows (two rows) of rectangular slabs extending in the longitudinal direction X and made of copper (Cu) and aluminum (Al) so that the multiple rows of rectangular slabs have different specific heat capacities. As a result, the specific heat capacity of the third portion 70c is set to have an intermediate magnitude between the specific heat capacity of the first portion 70a and the specific heat capacity of the second portion 70b.

FIGS. 7C to 7E are plan views of the thermal equalizers 70 according to modifications modified from the thermal equalizer 70 of FIG. 7A. Each of the thermal equalizers 70 in FIGS. 7C to 7E includes the third portion 70c including the part extending from the first portion 70a, forming the front side of the thermal equalizer 70, and made of copper (Cu) and the part extending from the second portion 70b, forming the back side of the thermal equalizer 70, and made of aluminum (Al). In FIG. 7C, the part made of copper and overlaid on the part made of aluminum (Al) forms one end of the third portion 70c in the transverse direction Y. In FIG. 7D, the part made of copper and overlaid on the part made of aluminum (Al) forms a center part of the third portion 70c in the transverse direction Y. In FIG. 7E, the part made of copper and overlaid on the part made of aluminum (Al) forms both ends of the third portion 70c in the transverse direction Y. The above-described structures can set the specific heat capacity of the third portion 70c to an intermediate magnitude between the specific heat capacity of the first portion 70a and the specific heat capacity of the second portion 70b.

FIG. 8A is views of a heating device according to modifications. As illustrated in FIG. 8A, the lengths of the first portion 70a and the second portion 70b in the longitudinal direction X are changed. As illustrated in FIG. 8A (b), the lengths of the second portions 70b in the longitudinal direction X are different. In the following description, the second portion 70b closer to the end electrodes 55 and 57 than the other second portion 70b is referred to as a connector-side second portion 70b, and the other second portion 70b is referred to as a non-connector-side second portion 70b. The connector-side second portion 70b is shorter than the non-connector-side second portion 70b.

Since the end electrodes 55 and 57 are disposed on one end of the base 50 extending from ends of the resistive strips 51a and 51b to one end of the base 50, the one end of the base 50 is longer than the other end of the base 50 extending from the other ends of the resistive strips 51a and 51b to the other end of the base 50. As a result, the thermal capacity of the one end of the base 50 is larger than the thermal capacity of the other end of the base 50 and is less likely to cause the temperature rise in the one end of the base 50. Accordingly, the connector-side second portion 70b on the one end of the base 50 can be shortened. However, increasing the length of the first portion 70a made of copper (Cu) toward the left side in the longitudinal direction X increases a space to set the thermal equalizer 70, which hinders the miniaturization of the device.

For the same reason, the connector-side second portion 70b is removed in FIG. 8A (c), and the first portion 70a made of copper (Cu) is extended instead of the connector-side second portion 70b. In FIG. 8A (d), the connector-side second portion 70b is formed by bonding a plate made of copper (Cu) and a plate made of aluminum (Al) in the thickness direction. In FIG. 8A (e), the connector-side second portion 70b is removed, and the first portion 70a made by bonding the plate made of copper (Cu) and the plate made of aluminum (Al) in the thickness direction is extended instead of the connector-side second portion 70b.

FIG. 8B is cross-sectional views of thermal equalizers 70 according to modifications. In these modifications, bonding different materials in the thickness direction forms the first portion 70a, the second portion 70b, and the third portion 70c of the thermal equalizer 70. In FIG. 8B (a), the thermal equalizer 70 includes a first layer made of aluminum (Al) and extending over the entire length of the thermal equalizer 70 in the longitudinal direction X. The first portion 70a is formed by bonding the first layer and a plate made of copper (Cu) as a second layer.

The second portion 70b is formed by boding a plate made of the same aluminum (Al) as a second layer on the first layer. The third portion 70c includes the first layer made of aluminum (Al), the second layer made of aluminum (Al), and a third layer made of copper (Cu), and the third layer is bonded on the second layer. The above-described structures can set the specific heat capacity of the third portion 70c to an intermediate magnitude between the specific heat capacity of the first portion 70a and the specific heat capacity of the second portion 70b.

In FIG. 8B (b), the thermal equalizer 70 includes a connector-side third portion 70c formed by bonding a plate made of copper (Cu) and a plate made of aluminum (Al). The non-connector-side second portion 70b and a non-connector-side third portion 70c are formed by a same plate made of aluminum (Al). Since the temperature of the end portion of the heater that is farther from the connector than the other end portion of the heater is more likely to rise than that on the other end portion of the heater, the non-connector-side second portion 70b and the non-connector-side third portion 70c are made of aluminum (Al) having a large specific heat capacity.

In FIG. 8B (c), the thermal equalizer 70 includes a first layer made of copper (Cu) and extending over the entire length of the thermal equalizer 70 in the longitudinal direction X. The first portion 70a and the third portions 70c are formed by bonding the first layer and a plate made of copper (Cu) as a second layer. The second portion 70b is formed by boding a plate made of aluminum (Al) as a second layer on the first layer.

In FIG. 8B (d), the thermal equalizer 70 includes the first layer made of copper (Cu) and extending over the entire length of the thermal equalizer 70 in the longitudinal direction X. The first portion 70a, the connector-side second portion 70b, and the third portions 70c are formed by bonding a plate made of copper (Cu) as a second layer on the first layer.

The non-connector-side second portion 70b is formed by bonding a plate made of aluminum (Al) as a second layer on the first layer. In this case, the specific heat capacity of the non-connector-side second portion 70b is largest, which enables preventing the excessive temperature rise of the end portion of the fixing belt that is farther from the connector than the other end portion of the fixing belt.

The temperature rise of the fixing belt is described below.

FIGS. 9A and 9B are diagrams each illustrating a temperature rise of the fixing belt 21 when the heater 23 according to the present embodiment is used. FIG. 9A illustrates a temperature rise of the fixing belt 21 when the maximum sheets pass through the fixing device, and FIG. 9B illustrates a temperature rise of the fixing belt 21 when the small sheets pass through the fixing device.

A thermistor 80 is disposed on the back side of the thermal equalizer 70 to detect temperature of the thermal equalizer 70. Based on the detected temperature, a controller controls electric power supplied from the end electrodes 55 and 57 to the resistive strips 51a and 51b to maintain the temperature within a predetermined target temperature range. In the longitudinal direction X, the thermistor 80 is positioned so as to face the outer end portion of the first portion 70a of the thermal equalizer 70 in the thickness direction.

In FIG. 9A, the non-sheet-passing regions are outside the maximum sheet P in the longitudinal direction X. Although the temperature rise is observed in the non-sheet-passing region, the maximum value of the temperature rise is significantly lower than an NG temperature. In FIG. 9B, the non-sheet-passing regions are outside the small sheet P in the longitudinal direction X. Although a larger temperature rise than that in FIG. 9A is observed, the maximum value of the temperature rise is sufficiently lower than the NG temperature.

In contrast, FIGS. 9C and 9D are diagrams each illustrating a temperature rise of the fixing belt 21 when the heater 23′ according to the comparative example is used. In FIGS. 9C and 9D, each of the resistive strips 51a and 51b has a constant width in the transverse direction Y in an entire region from a central region to both end regions.

In the above-described structure, as illustrated in FIG. 9C, the temperature of the non-sheet-passing region is close to the NG temperature even when the maximum sheets pass through the fixing device. When the small sheets pass through the fixing device, the temperature of the non-sheet-passing region largely exceeds the NG temperature as illustrated in FIG. 9D.

The present disclosure has been described above on the basis of the embodiments, but the present disclosure is not limited to the embodiments. Needless to say, various alterations can be made in the scope of the technical idea described in the scope of the claims. The following describes preferred aspects of the present disclosure.

### First Aspect

In a first aspect, the heating device has the following features. The heating device includes a pressure rotator, a heating rotator, an electrode, an electric conductor, a resistive strip, and a thermal equalizer. A nip is formed between the pressure rotator and the heating rotator. A heated member having a sheet shape passes through the nip in a conveyance direction. A transverse direction is defined as the same direction as the conveyance direction, and a longitudinal direction is defined as a direction orthogonal to the transverse direction. The resistive strip extends in the longitudinal direction and is disposed inside the loop of the heating rotator. An end of the resistive strip in the longitudinal direction is coupled to the electrode to supply electric power to the resistive strip via the electric conductor. The resistive strip has a nip side face and an opposite side face opposite to the nip side face in a thickness direction of the resistive strip. The thermal equalizer faces the side face opposite to the nip side face, extends in the longitudinal direction, and is configured by multiple materials having different specific heat capacities. The resistive strip has a central region and an end region adjacent to the central regions in the longitudinal direction. The central region is in a center portion of the resistive strip in the longitudinal direction and has a first width in the transverse direction. The end region is at an end of the resistive strip in the longitudinal direction and has a second width in the transverse direction that is larger than the first width.

### Second Aspect

In a second aspect, the heating device according to the first aspect has the following features. The thermal equalizer includes a clad material including a first portion having a first specific heat capacity and a second portion having a second specific heat capacity larger than the first specific heat capacity. The first portion is a central portion of the thermal equalizer in the longitudinal direction and overlaps the central region of the resistive strip in the thickness direction. The second portion is an end portion of the thermal equalizer in the longitudinal direction and overlaps the end region of the resistive strip in the thickness direction.

### Third Aspect

In a third aspect, the heating device according to the second aspect is characterized in that the second portion of the thermal equalizer is disposed adjacent to a non-sheet-passing region where the heated member does not pass through.

### Fourth Aspect

In a fourth aspect, the heating device according to the second aspect or the third aspect is characterized in that the end region of the resistive strip overlaps a boundary between the first portion of the thermal equalizer and the second portion of the thermal equalizer in the thickness direction.

### Fifth Aspect

In a fifth aspect, the heating device according to any one of the second to fourth aspects is characterized in that the first portion is made of copper, and the second portion is made of aluminum.

### Sixth Aspect

In a sixth aspect, the heating device according to any one of the second to fifth aspects has the following features. The thermal equalizer has three portions having different specific heat capacities. The first portion having the smallest specific heat capacity is the central portion of the thermal equalizer in the longitudinal direction and faces the central region of the resistive strip. The second portion having the largest specific heat capacity is the end portion of the thermal equalizer in the longitudinal direction and faces the end region of the resistive strip. A third portion having an intermediate specific heat capacity is disposed between the first portion and the second portion. The end region of the resistive strip overlaps a boundary between the second portion of the thermal equalizer and the third portion of the thermal equalizer in the thickness direction.

### Seventh Aspect

In a seventh aspect, the heating device according to the sixth aspect is characterized in that the third portion includes multiple materials having different specific heat capacities and layered in the thickness direction of the thermal equalizer.

### Eighth Aspect

In an eighth aspect, the heating device according to the sixth aspect or the seventh aspect is characterized in that the third portion includes multiple rows of rectangular slabs extending in the longitudinal direction, and the multiple rows of rectangular slabs have different specific heat capacities from each other.

### Ninth Aspect

In a ninth aspect, a fixing device includes the heating device according to any one of the first to eighth aspects.

### Tenth Aspect

In a tenth aspect, an image forming apparatus includes the fixing device according to the ninth aspect.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A heating device comprising:
a pressure rotator;
a heating rotator:
having a loop; and
forming a nip between the pressure rotator and the heating rotator, the nip through which a sheet passes in a conveyance direction;
an electrode;
an electric conductor coupled to the electrode;
a resistive strip:
disposed inside the loop of the heating rotator;
extending in a longitudinal direction orthogonal to the conveyance direction; and
having:
a central region in the longitudinal direction, the central region having a first width in a transverse direction parallel to the conveyance direction and orthogonal to the longitudinal direction;
an end region:
adjacent to the central region in the longitudinal direction;
having an end coupled to the electrode via the electric conductor; and
having a second width larger than the first width in the transverse direction;
a nip side face facing the nip; and
an opposite side face opposite to the nip side face in a thickness direction orthogonal to the longitudinal direction and the transverse direction; and
a thermal equalizer:
facing the opposite side face of the resistive strip;
extending in the longitudinal direction; and
including multiple materials having different specific heat capacities.

2. The heating device according to claim 1,
wherein the thermal equalizer includes a clad material including:
a first portion:
forming a central portion of the thermal equalizer in the longitudinal direction;
overlapping the central region of the resistive strip in the thickness direction; and
having a first specific heat capacity; and
a second portion:
forming an end portion adjacent to the first portion in the longitudinal direction; and
overlapping the end region of the resistive strip in the thickness direction; and
having a second specific heat capacity larger than the first specific heat capacity.

3. The heating device according to claim 2,
wherein the heating rotator has:
a passing region through which the sheet passes; and
a non-passing region outside the passing region in the longitudinal direction, and
the second portion of the thermal equalizer faces the non-passing region of the heating rotator.

4. The heating device according to claim 3,
wherein the thermal equalizer has a boundary between the first portion and the second portion in the longitudinal direction, and
the end region of the resistive strip overlaps the boundary in the thickness direction.

5. The heating device according to claim 2,
wherein the first portion is made of copper, and
the second portion is made of aluminum.

6. The heating device according to claim 1,
wherein the thermal equalizer includes
three portions having different specific heat capacities and including:
a first portion:
forming a central portion of the thermal equalizer in the longitudinal direction;
facing the central region of the resistive strip; and
having a smallest specific heat capacity among the specific heat capacities of the three portions;
a second portion:
forming an end portion of the thermal equalizer in the longitudinal direction;
facing the end region of the resistive strip; and
having a largest specific heat capacity among the specific heat capacities of the three portions; and
a third portion between the first portion and the second portion, and
the end region of the resistive strip overlaps a boundary between the second portion of the thermal equalizer and the third portion of the thermal equalizer in the thickness direction.

7. The heating device according to claim 6,
wherein the third portion includes multiple layers layered in the thickness direction and having different specific heat capacities.

8. The heating device according to claim 7,
wherein the third portion includes multiple rows of rectangular slabs extending in the longitudinal direction, and the multiple rows of rectangular slabs have different specific heat capacities from each other.

9. A fixing device comprising the heating device according to claim 1.

10. An image forming apparatus comprising:
an image forming unit to form an image on a medium; and
the fixing device according to claim 9 to fix the image on the medium.
